(19) United States
(12) Patent Application Publication
(10) Pub. No.: US 2018/0233063 A1
(43) Pub. Date: Aug. 16, 2018

(54) TOILET TRAINING SYSTEM

(71) Applicant: Tot on the Pot, LLC, Mount Airy, MD (US)

(72) Inventors: ELLIOT TOTAH, Washington, DC (US); JACQUELINE LEVERTON, Mount Airy, MD (US)

(73) Assignee: Tot on the Pot, LLC, Mount Airy, MD (US)

(21) Appl. No.: 15/869,479

(22) Filed: Jan. 12, 2018

Related U.S. Application Data
(60) Provisional application No. 62/446,175, filed on Jan. 13, 2017.

(51) Int. Cl. G09B 19/00; A63H 3/02; A63H 3/52; A63H 33/30

(52) U.S. Cl. CPC G09B 19/0076; A63H 33/30; A63H 3/52; A63H 3/02

(57) ABSTRACT

A toilet training system is providing with a toy toilet having at least two reward storage containers. A plurality of reward cards is each sized to be received in the reward storage containers. A doll is sized to be positioned on the toy toilet. Each of the two reward storage containers are accessible to receive at least one of the plurality of reward cards while the doll is positioned on the toy toilet.

### CROSS-REFERENCE TO RELATED APPLICATIONS

This application claims the benefit of U.S. provisional application Ser. No. 62/446,175 filed Jan. 13, 2017, the disclosure of which is hereby incorporated in its entirety by reference herein.

### TECHNICAL FIELD

The present application is directed to toilet training system and toy for children.

### BACKGROUND

Toilet training is an important and necessary process for parents and their toddlers to engage in at the right time. Successful completion of the process can be very gratifying for both parties. For parents, they no longer have to take the time and incur the expense of diaper changes. It also provides them with greater flexibility in choosing care options for their children (some schools/daycares have limitations for children who are not toilet trained). For the children, it gives them an increased sense of independence and maturity, and it builds their self-confidence. It is ultimately better for their health (avoids the possibility of diaper rash) and promotes social skills. Toilet training also benefits the environment since it reduces the amount of waste (i.e. disposable diapers) that we create and that the earth must consume.

While toilet training has many benefits, the process can be a stressful and challenging one. Parents must first correctly gauge when their child demonstrates the necessary understanding, development and self-control to undertake the responsibilities of toilet training. Once that point has been reached, they must determine how to adequately and comprehensively explain the toilet training process including its relevance, its applicability and its procedures. They must ensure that they provide their children with the proper encouragement and incentives to pursue a successful transition away from diapers. This can require a good deal of planning, research and expense for the parents as they acquire the knowledge base and the materials they will need to succeed in toilet training their child. Meanwhile, the process can also be a significant and onerous one for children. Embracing an entirely new approach to going pee and poo in terms of timing, location and thought process can be very daunting. The toilet training process is one that children must inherently perform alone—they are the only one that knows when they need to use the toilet and they are the only one who can control themselves until they arrive at the toilet. The pressure of going through this process by themselves can place a significant burden on the child since they have no outlet for expressing their potential feelings of stress, concern and frustration. From the child's perspective, the effortless and convenient use of a diaper is replaced by a more complex model that requires self-control and patience.

Many tools exist to explain/illustrate the toilet training process to a child or to provide some reward to a child upon achieving success at the toilet. However, none of these products have provided a comprehensive solution for both parents and children which respond to the many stresses that both parties face on their way to toilet training success.

### SUMMARY

According to at least one embodiment, a toilet training system is provided having a toy toilet with an external reward receptacle and an internal reward storage chamber. A plurality of reward cards is each sized to be received in the external reward receptacle and internal reward storage chamber.

In another embodiment, the toilet training system has a doll sized to be positioned on the toy toilet.

In another embodiment, the doll has a rear portion formed to cooperate with a lid of the toy toilet to maintain the doll in a seated position on the toy toilet.

In another embodiment, the rear portion of the doll is filled with a material being denser than a body filling material which fills a body of the doll.

In another embodiment, the toilet training system has a book having toilet training instructions relating to the toy toilet and the doll.

In another embodiment, the toy toilet has a slot extending from an exterior surface to the internal reward storage chamber, the slot sized to receive at least one of the plurality of reward cards.

In another embodiment, the external rewards receptacle is formed on a first lateral side of the toy toilet and the slot is formed on a second lateral side of the toy toilet.

In another embodiment, the toy toilet has a lid hinged to pivot between an open position and a closed position. In the open position, the internal reward storage chamber is accessible and in the closed position, the internal reward storage chamber is concealed.

In another embodiment, each of the of reward cards have an interactive activity instruction.

According to at least one other embodiment, a toilet training system is provided with a toy toilet having a reward system. A plurality of reward pieces is each sized to be received in the reward system.

In another embodiment, reward system comprises an external reward pocket sized to receive at least one of the reward pieces.

In another embodiment, the plurality of reward pieces comprises a plurality of cards.

According to at least one other embodiment, a toilet training system is providing with a toy toilet having at least two reward storage containers. A plurality of reward cards is each sized to be received in the reward storage containers. A doll is sized to be positioned on the toy toilet. Each of the two reward storage containers are accessible to receive at least one of the plurality of reward cards while the doll is positioned on the toy toilet.

According to at least one other embodiment, a toilet training system in provided. The toilet training system includes a doll having a body and a rear-end portion with a filling different than the rest of the body. A toy toilet has a toilet seat enclosing a storage chamber and having a receiving portion sized to receive the rear-end portion of the doll. A reward center is disposed on a side of the toilet and sized to hold at least one reward card. A slot is formed on the toilet and sized to receive at least one of the plurality of activity cards, the slot extends from an outer surface of the toy toilet to the storage chamber. A first compartment is positioned in the storage chamber adjacent to the slot. The first compartment is sized to hold a first plurality of reward cards in a first orientation. A second compartment is positioned in the storage chamber. The second compartment is sized to hold a second plurality of reward cards in a second orientation.

### BRIEF DESCRIPTION OF THE DRAWINGS

FIG. 1 is a perspective view of the toilet training system.

FIG. 2 is a right-side view perspective of the toy toilet with the lid closed and reward cards partially inserted in a return slot.

FIG. 3 is a left-side perspective view of the toy toilet with.

FIG. 4 is a top perspective view of the toy toilet with the lid open illustrating the internal chamber.

FIG. 5 is a right-side perspective view of the toy toilet with the lid open illustrating the internal chamber storing reward cards.

### DETAILED DESCRIPTION

As required, detailed embodiments of the present invention are disclosed herein; however, it is to be understood that the disclosed embodiments are merely exemplary of the invention that may be embodied in various and alternative forms. The figures are not necessarily to scale; some features may be exaggerated or minimized to show details of particular components. Therefore, specific structural and functional details disclosed herein are not to be interpreted as limiting, but merely as a representative basis for teaching one skilled in the art to variously employ the present invention.

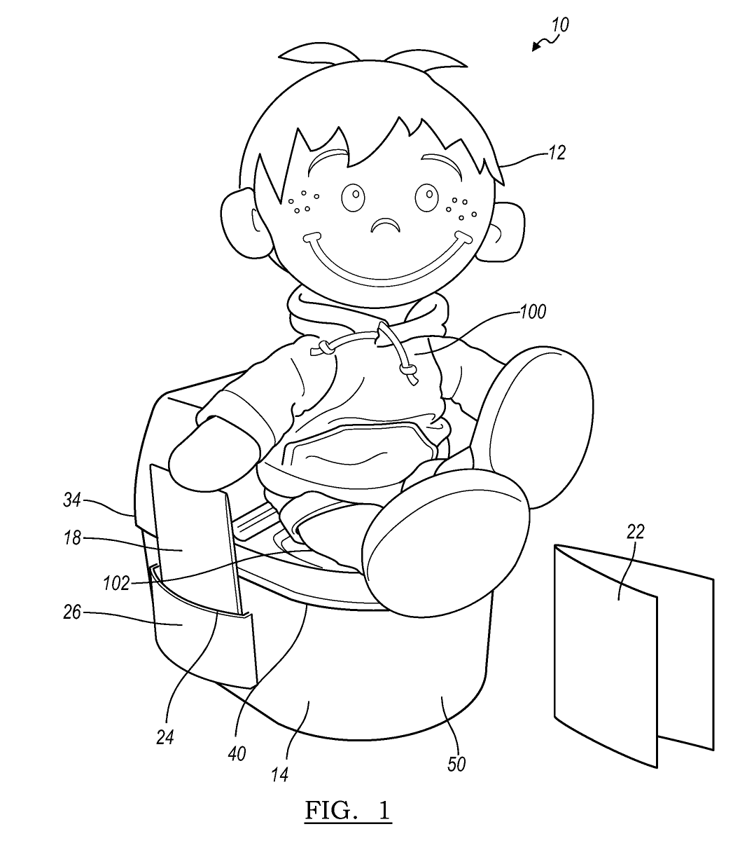

FIG. 1 illustrates the toilet training system 10. The toilet training system 10 is a comprehensive instructive toy that provides parents and their toddlers with a way to explain, engage in and reward the often-daunting task of learning to use a toilet. The toilet training system 10 includes a plush doll 12, a toy toilet 14 with an integrated rewards center 16, a set of cards 18 with a series of imaginative reward activities and an instructional book 22 to explain and prompt a discussion about toilet training.

The toilet training system 10 includes a plush doll 12, which is given to children when they start the process of toilet training. The doll 12 is typically in the shape of a toddler/child, but may resemble any suitable character or animal, for example. The doll 12 is the child's companion throughout the process and a reminder of the positive incentives that await them upon each successful toilet visit. Children form a bond with the doll 12 by carrying around, playing and identifying with the doll 12 throughout their normal daily activities. The doll 12 may come in both male and female genders, as well as a variety of skin tones to ensure an inclusive and identifiable experience.

The toy toilet 14 resembles the shape and features of a full-sized toilet. The toy toilet 14 is used by the plush doll 12 to accompany the toddler on their visit to the toilet. The toy toilet 14 includes a reward center 16 and holds various rewards cards 18 that are made accessible to the toddler upon a successful toilet visit. The reward center 16 is the climax of every visit to the toilet. The reward center 16 includes a pocket 20 formed on one side of the toy toilet 14 to hold a reward card 18 for the child. A slot 28 is formed on the opposite side of the toy toilet 14 for depositing the card 18 once the reward activity described on the has been completed. Inside the toy toilet 14 is a compartmentalized storage chamber 30 where new activity cards 18 await and old activity cards 18 are accumulated after use.

The reward cards 18 present an imaginative and interactive reward activity for the parent and the toddler to complete together in celebration of a successful toilet visit. For example, the reward cards 18 may include instructions for an activity such as performing a song and a dance, role playing, or making funny faces in the mirror, or instructions for any other interactive reward activity that where the child interacts with the parent, or even the doll. Each of the activity cards 18 is designed to be interactive and engage the parent and toddler in a short activity, such as a three to five-minute activity, that both participants will enjoy. These activities encourage positive parent-toddler interaction and provide the parent with a method to rejoice in their child's success without the need to procure materials or arrange for a particular setting. The rewards card 18 also may be other reward pieces or reward cards that provide positive reinforcement to the child after using the adult toilet.

The toilet training system 10 also includes a book 22 which is a fun and colorful explanatory guide and explains use of the toilet and responds to the questions toddlers will have about toilet training. In an enjoyable and whimsical way, the book responds to toddlers' inquiries about when, where, why and how the toilet is used. Parents are relieved of the need to explain the basics of toilet training and may rely on the book and the entertaining and informative narrative to inform and instruct their toddlers about toilet training. The book can and should be read over and over to reinforce the toilet training process. The book 22 also explains the toilet training system 10 and the active roll the doll 12, the toy toilet 14, and the cards 18 will play in the toilet training process.

Upon opening packaging for the toilet training system 10, toddlers are given the plush doll 12 and they are told that this doll 12 will be their friend and partner as the child learns to use the toilet. The child can play with the doll 12 throughout the day and the doll 12 participates in all the activities in which the toddler will normally engage (e.g. visiting the playground, playing in the home, going to sleep together, etc.). The child forms a bond with the doll 12 and begins to identify with the doll 12. This is particularly relevant as the parent introduces the prospect of toilet training and uses the instructive book to explain the process. Since the doll 12 is also featured in the book 22, the child begins to understand that just as the doll 12 will use learn to use the toy toilet 14, so too will the child begin to do so.

The parent then reads the book 22 to the child, with a frequency determined by the parent and/or child, to introduce the practice of using the toilet and explain why it is relevant. The parent is able to rely on the toilet training system 10 to address all facets of the process of using the toilet, such as pulling down the pants, sitting on the toilet, hearing the pee/poop enter the toilet, wiping afterwards and washing hands. The toilet training system 10 puts toilet use into perspective for the child so they understand its importance. At the same time, the child is inspired by the entertaining, illustrated and thought-provoking narrative in the book 22 to get excited about toilet training. In doing so, the child begins to look forward to engaging in toilet training with their doll 12 and joining other children and adults in use of the toilet. The book 22 goes on to explain the toilet training system 10 process to the child which entails joint toilet visits with their doll and the resulting celebratory activities with their parent. The book 22 has a front cover and a back cover with several intermediary pages joined by binding. The book 22 may be printed on cardboard, rubber, cloth or other similar materials which are difficult to rip and generally hold up to a toddler's wear and tear.

The toy toilet 14 comes into play at such time as the child is ready to begin transitioning to actual use of a toilet. The toy toilet 14 should be placed adjacent to the child's toilet. At such time as the child needs to use the toilet, they seat their doll 12 on the toy toilet 14 while they are seating themselves on their own toilet, either a child-size training toilet or an adult-size toilet, for example. The doll 12 essentially accompanies the toddler in this new activity and provides companionship to the child while they establish a new comfort zone around this new method of going pee/poop. Upon the child's successful completion of toilet use, the child is rewarded with the reward center 24 on the toy toilet 14. The child is able to pluck an activity card 18 out of the pocket located on the side of the toy toilet 14 and engage in a reward activity described on the card 18. The reward activity allows the child to engage in an imaginative, humorous and/or symbolic activity with their parent and doll 12 to celebrate their success. Each activity is dynamic and open to personalization—in other words, if the activity calls for a child and his parent to make faces in the mirror expressing various emotions, no two parents/children will make the same faces and each will be able to craft the activity to best fit their preferences. This activity lifts the child's spirits, engages their imagination and build's anticipation towards the next successful toilet visit and the new activity that will await them.

Once the activity is completed, the child deposits the activity card 18 into a slot 28 on the opposite side of the toy toilet 14. The slot 28 is connected to a storage chamber 30 in the toy toilet 14. Once the child deposits the activity card in the storage chamber 30, the child can return to their routine with their doll 12, having been rewarded, encouraged and entertained by the entire experience using the toilet. The doll 12 remains at the child's side and serves as a constant reminder of the next toilet visit.

The toy toilet 14 and the reward center 16 become a source of excitement and positive association since using the toilet means that the child gets to engage in role playing with their doll 12, positive encouragement upon use of the toilet, and celebration in the form of an unknown and dynamic set of activities in the rewards center 16 that await them. Children begin to pay particular attention to their urge to use the toilet to ensure they don't miss out on an opportunity to interact with the toy toilet 14 and reap its rewards that await them. It is important to note that the activities listed on the activity cards 18 are designed to be entirely self-contained and all-inclusive—i.e. they require no materials that wouldn't be easily procurable in every home and they contain no conditions. In this respect, the activity cards 18 are an ideal reward from the parent's perspective since they don't create a burden of execution with the parent having to scramble to satisfy an activity's preconditions.

Overall, the toilet training system 10 allows children to engage in symbolic, imaginative and dramatic play while learning an important new skill which is constantly encouraged through positive associations. Each successful use of the toilet reinforces the relevance of the toilet training system 10 and builds anticipation towards the next successful visit. Children are organically steered towards embracing the use of the toilet instead of seeing it as a stressful or burdensome new obligation being imposed upon them. Simultaneously, the three overarching stages of toilet training—Inform (informing both parents and children as to their roles and responsibilities), Incentivize (incentivizing children to recognize their body's urges and prioritize use of the toilet), and Reward (providing children with praise and a bonus for toilet use to encourage a continued use pattern)—are comprehensively addressed for parents. Parents are relieved of the burden of explaining toilet training and creating a constructive reward system to encourage its successful execution. They are able to rely on the toilet training system 10 to answer their children's questions, remind their children to identify the urge to use the toilet and incentivize their children to do so successfully to realize the prize that awaits them on the other end.

The toy toilet 14, illustrated in FIGS. 1-5, may be manufactured from plastic, bioplastics, wood, rubber, natural rubber, bamboo or other similar materials. The overall form of the toy toilet 14 is comparable yet scaled from that of a full-sized hollow toilet and is sized appropriately to ensure that the doll 12 can be seated upon it and remain in place. The tank portion 34 of the toy toilet 14 most closely simulates the tank on a regular toilet and is shaped as a rectangular prism and forms a rear portion of the toy toilet 14. A front wall 38 of the tank 34 is sized to have a width and height to support the doll 12 when the doll 12 is seated on the toy toilet 14, as shown in FIG. 1. An inside surface of the front wall 38 may have a magnet to aid in the doll 12 in remaining seated on the toy toilet 14 when in use. Alternatively, the front wall 38 may include a fastener such as a magnet, Velcro, snap button or other similar fastener to aid in the doll 12 to remain seated on the toy toilet 14 when in use. The front wall 38 or other surface of the rear tank portion 34 may have one or more of a variety of designs on it such as a picture of the doll, a sticker chart, the product logo or an area in which the toy toilet 14 may be personalized for its intended recipient.

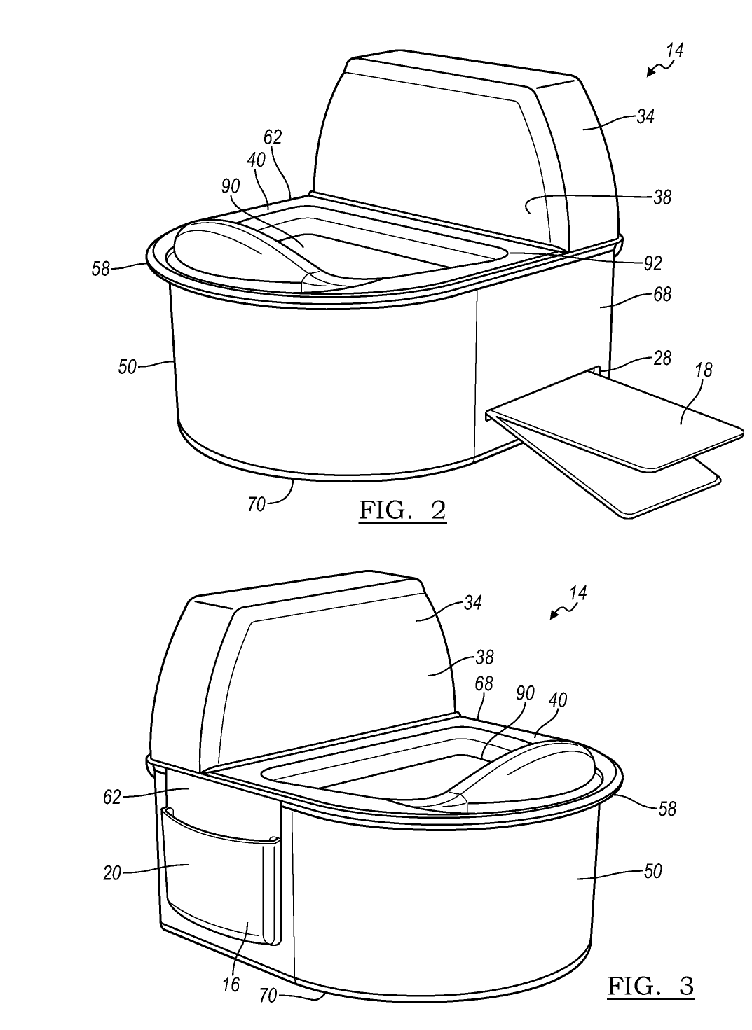

The toilet lid 40 is connected to the bowl portion 50 along a hinge 42. As shown in FIGS. 2-5, the toilet lid 40 may be integrally formed with the tank portion 34. The lid 40 is attached to a rear surface 44 of the toy toilet 14. The lid 40 may be attached along the rear surface to pivot with clips snaps, ball and socket or any suitable hinge or attachment means that allows the lid 40 to be raised and lowered. The edges of the tank portion 34 are all slightly curved or chamfered to eliminate corners or edges that would create a potential hazard for the child interacting with the toy toilet. The toy toilet 14 may also have a splash guard along the front of the seat and/or a flushing handle.

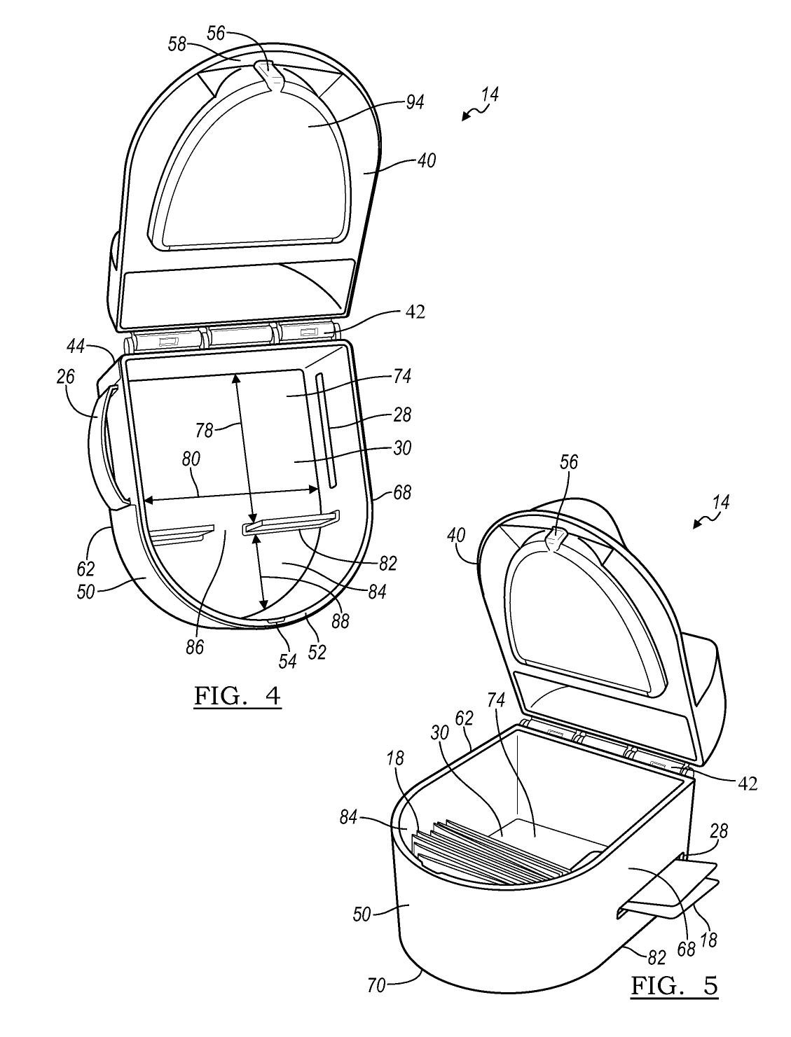

The bowl portion 50 of the toy toilet 14 is horseshoe-shaped or half-oval shaped and is designed to resemble the bowl of a full-sized toilet. The bowl portion 50 extends forward from tank portion 34. At the apex 52 of the bowl portion 50 a latch feature 54 is formed. As shown in FIGS. 4-5, an engagement feature 56 is formed on the lid 40 and is sized to engage the latch feature 54 when the lid 40 is in a closed position. As shown in Figures, the latch feature 54 is a groove and the engagement feature 56 is a detent. The detent 56 may be retained in the groove 54 with an interference fit, such as a snap fit, to maintain the lid 40 in the closed position. Any suitable latch and engagement features 54, 56 may be used, such as a pin and mating hole, to ensure the toilet lid 40 does not inadvertently lift or open up when the toy toilet 14 is inverted or when not intentionally opened for access to the activity cards housed in the storage chamber 30. The lid 40 may also have a slightly raised lip horizontally offset from the seat's apex 52 to facilitate lifting the seat and accessing the activity card storage chamber 30. The lid 40 may be slightly larger than the bowl creating an outer ledge. This outer ledge 58 that protrudes along the outer perimeter of bowl portion 50 aids in lifting the lid to access the storage chamber 30.

On a first lateral side 62 of the toy toilet's 14, horizontally offset slightly from the rear surface 44 of the toy toilet 14, is an exterior receptacle formed as a pocket 26 which to house the activity cards 18. The pocket 26 is positioned along a generally flat exterior lateral surface 62 of the toy toilet 14. The pocket 26 is sized to hold an activity card 18 without bending the card. Furthermore, since the pocket 26 is intended to contain an activity card at most times, the pocket 26 is located along the side of the unit so that the activity card 18 does not create interference when the doll 12 is seated on the toilet lid 40, as shown in FIG. 1. The pocket 26 may be 1.2-1.3 times the width of the activity card 18. The pocket 26 is wide enough so that activity cards 18 can be easily inserted and removed, and deep enough to ensure that the pocket 26 can comfortably hold the card 18 without the card falling out. The pocket 26 is positioned to ensure that the activity card 18, when located in the pocket 26, has enough of its surface area exposed beyond the tank portion 34 of the toy toilet 14 to ensure easy and convenient access to the card, inclusive of the acts of inserting and removing the card. The depth of the pocket 26 may be such that a card 18 can be easily inserted but that it will remain standing up straight and will not lean outwards or not be properly supported. The pocket 26 may be integrally molded with the toy toilet 14. Alternatively, the pocket may be attached to the toy toilet with adhesive or any suitable attachment mechanism.

On the opposite lateral side 68 of the toy toilet 14 is a slot 28 into which activity cards 18 are deposited once they have been used. The slot 28 may be approximately the same width as the pocket 26 and is horizontally offset from the rear surface 44 of the toy toilet 14 the same distance as the pocket 26 on the opposite lateral side 62. The height of the slot 28 may be seven to ten times the thickness of the activity cards to ensure that the cards 18 can be easily inserted. The vertical position of the slot 28 from the base 70 of the toy toilet 14 is sufficient so that up to thirty activity cards can be deposited into the storage chamber 30 without having the accumulated cards cover the slot 28. Alternatively, the slot 28 could be located along a rear surface 44 of the tank portion 34. This would provide another access to the storage chamber 30.

The interior storage chamber 30 is shown in more detail in FIGS. 4-5. The storage chamber 30 of the toy toilet 14 holds both the used and unused activity cards 18. The width 80 of the interior of the toy toilet 14 is sized sufficient to accommodate the length of the activity cards 18 which is housed within, with additional room (such as an additional 12% of the length of the activity card) to ensure the cards 18 can be comfortably inserted and removed. For example, the internal width 80 may be approximately four inches wide. The external width between the lateral sides 62, 68 may be generally five inches wide.

The storage chamber 30 of the interior of the toy toilet 14 includes a divider 82 which will create two separate chambers: a rear compartment 74 and a front compartment 84. The front compartment 84 houses the unused activity cards 18 standing up on their long side in a first standing orientation. The front compartment 84 may be large enough to comfortably accommodate one to thirty or more activity cards in this standing position. The slot 28 is positioned to deposit cards into the rear compartment 74 of the storage chamber 30. The rear compartment 74 houses the used activity cards 18 lying flat in a second orientation after having been inserted through the slot 28. The rear compartment 74 is large enough to accommodate the activity cards lying flat with at least 10% additional area for maneuvering room. The divider 82, which separates the two compartments 74, 84 may have a finger gap 88 in the middle to facilitate the removal of either the used or unused cards 18 from the storage chamber 30. The divider 82 is tall enough to ensure that the standing, unused activity cards 18 do not tip over and mix with the used activity cards. In one embodiment, the rear compartment 74 has a length 78 being generally 3.25 inches, whereas the front compartment 84 has a length 88 being 1.25 inches. However, the inside compartment may be any suitable sizes for holding a reward piece.

The lid 40 has a similar horseshoe/semi-oval shape as the bowl portion 50 of the toy toilet 14. The center of the lid 40 contains a depressed portion 90 that is concave from an upper surface 92 of the lid 40. The depressed portion 90 may be proportional to the opening on a regular toilet seat and as such may occupy 40-80% of the surface area of the lid 40. A magnet may be included along an inner surface 94 of the lid 40 to aid in the doll 12 remaining on the seated on the toy toilet 14. Alternatively, a magnet, Velcro, snap button or other similar item may be attached the depressed portion 90 or the upper surface to aid in the doll remaining on the seat when the toy toilet 14 is in use.

The toilet training system 10 also includes reward pieces being activity cards 18. The activity cards 18 include colored print and drawings printed on cardstock, cardboard or other similar materials. The cards may also include the product's logo and/or the cognitive benefits associated with the activity described thereon. Each card 18 may include a different activity for the child and their caregiver to engage in when relevant. The activity cards may be approximately seven inches in length by two inches in width and creased to also the cards to be folded in half. The activity cards 18 may be any size that will allow the activities to be printed in a font that is easily readable, while ensuring that, they can be housed in the storage chamber 30 and side pocket 26. One side of the card 18 may include a written description of the activity. The other side may include a drawing specifically laid out to be visible and seen by the child when placed in the pocket 26. The drawing may directly relate to the activity described on the card.

The doll 12 may be either male and female genders, as well as multiple different skin tones to represent various nationalities and races. In alternative forms, the doll 12 may take on the shape/identity of animals, robots and/or other anthropomorphized characters. The doll 12 may come with a variety of outfits, costumes and associated accessories. Regardless of character, the doll 12 may have arms, legs, embroidered facial features, buttocks and/or genitalia. The exterior of the doll 12 may generally be made out of velboa, plush, terrycloth or other similar fabrics. However, the exterior of the doll 12 may be made of any suitable materials.

The body filling of the dolls body 100 including the legs, arms, and head, may be polyester, synthetic fiber batting, cotton, straw or other comparable materials. The filling in the doll's rear end 102 is beans, pellets, or similar materials that have a greater density than the body filling. The higher mass in the rear end 102 of the doll ensures that the doll's rear end is properly weighted so as to remain seated on the toy toilet 14 while accompanying the child during toilet visits. The doll 12 may also always have a set of underwear that can be raised or lowered to augment the doll's accompaniment of the child during toilet visits. This allows the child to further identify with the doll 12 in that both would go through the same motions upon arriving at their respective toilets. The doll 12 may also have other components specifically intended to facilitate/ensure that it remains seated on the toy toilet during a child's toilet visit. Such components may include an interior magnet or exterior Velcro, clips, snaps, buttons, or other suitable fastener to maintain the doll 12 on the toilet seat.

The toilet training system 10 may also include a ruler. The ruler may be made of paper, cloth, string, plastic or other suitable materials and have marking to indicate an appropriate length of toilet paper and to help the child gauge how much toilet paper is the right amount. The ruler may be attached to the toilet paper holder by a fastener or other suitable attachment means. Alternatively, the ruler may be attached to the wall adjacent the toilet paper holder with adhesive or formed as a sticker. The child would pull toilet paper down until the ruler's end or to one of the markings and then know to rip the toilet paper off at the appropriate length. The goal of the ruler 200 is to help reduce the likelihood of the child pulling off too much toilet paper.

The toilet training system 10 was carefully designed to encourage several different positive dynamics for a child during the toilet training process. The toilet training system 10 provides numerous cognitive and developmental benefits.

Firstly, the use of a doll 12 to accompany the child throughout his/her toilet training is very important. In almost all cases, the nature of the toilet training process is one that causes children to undergo it alone. It takes place at home so they can't experience it with friends. Unless they have a twin, it is unlikely that they will have a sibling going through the process at the same time. Also, since each child has to go to the bathroom at different times, toilet visits are activities that they perform individually. All of these elements combine to create a process where the child is isolated from their peers and unable to share their experiences and emotions with anyone. This makes the doll 12 a welcome addition to toilet training. Stuffed animals and dolls are children's first friends. Emotions are tested out on these friends—they may be hugged, kissed, thrown around and spoken to. Children are able to perform activities with dolls as their companion, or they are able to practice early parenting skills and become the providers of the treatment they normally receive. By having a doll specifically intended to accompany them through toilet training, they are no longer alone as they make their toilet visits. They have someone they can interact with who is going through the same process. The doll 12 becomes their sounding board for their excitement and their frustration. It serves as their companion in their successes and their failures. Instead of going at it alone, the child has a partner in crime . . . or more appropriately, a partner in poop.

The second important developmental aspect of the toilet training system 10 is that it provides the child with an immediate reward upon the successful completion of using the toilet. Rewards are generally a positive and encouraging factor for children since they celebrate the successful completion of a task (as opposed to a bribe which is given before completion to incentivize performance and could become a crutch for future performance of the same task). Rewards can be used to increase self-esteem. Rewards can be used to increase self-esteem of the child. When a child earns a reward, he knows he has done something good.

Rewards can also help improve the parent's relationship with their child. When the child is given a reward by the parent, both the parent and the child are both happy. The parent happy because their child has done something they like. The child is also happy because she is getting something she likes.

The toilet training system 10 system provides the right type of reward since the resulting activity is cost-free and part of the toilet training system 10 and therefore is directly tied to the act of using the toilet. Accordingly, the child is able to directly associate the receipt of the reward with the act of using the toilet—i.e. they understand exactly why they are being rewarded. Also, since there is a different activity card 18 for each toilet visit, the reward is new and different every time. The child never grows accustomed to receiving the same reward and therefore, their anticipation to receive it never abates. Lastly, the fact that the rewards are constructive activities helps to avoid creating detrimental expectations in one's child such as those associated with rewards more pervasively used (such as candy and/or TV/screen time).

The third important developmental benefit of using the toilet training system 10 system is that it encourages playtime with parents. As dual income households become more prevalent, parents have less time to spend with their children. The toilet training system 10 process creates an important opportunity for parents to have positive interaction with their child. Just as importantly, it creates an interaction that does not place a burden of preparation or procurement on the parent. The interactions that occur through play tell children that parents are fully paying attention to them and help to build enduring relationships. Parents who have the opportunity to glimpse into their children's world learn to communicate more effectively with their children and are given another setting to offer gentle, nurturing guidance. Less verbal children may be able to express their views, experiences, and even frustrations through play, allowing their parents an opportunity to gain a fuller understanding of their perspective. Play offers parents a wonderful opportunity to engage fully with their children.

The fourth and final development benefit of using the toilet training system 10 is the particular type of play that the reward activities encourage: imaginative/pretend play. There are many different ways to play with and engage a child. Pretend play is one of those ways and holds very unique and important benefits. Engaging in this form of play enhances a toddler's cognitive development. Just the act of pretending is a learning curve for a child. It grants them with an outlet to role play what they have seen in their world. This helps them learn about how the world works and practice how adults interact. Not only does it help with social skills but it encourages a child to put themselves in someone else's shoes and be empathetic and considerate of others. This gives them a chance to practice behavior, manners and language that is needed when they interact in real world situations, as well as what behavior is acceptable in public. Dramatic pretend play encourages expressive language that would not otherwise be used by the child. Often through pretend play, withdrawn children can first start to express themselves by acting a certain role. Further, this gives the parent an opportunity to extend on language skills by paraphrasing what the child has said using more descriptive language and exchanging conversations using expressive language examples. Dramatic pretend play is great for showing how imaginative children are. Imagination is an important building block for learning. It is not only important in childhood; imagination is crucial for life. Just imagine a world without it, we would not have scientists making new discoveries, artists making new artworks, Santa traditions, award winning stories like Avatar and we would not be able to cognitively process these possibilities or examples.

While exemplary embodiments are described above, it is not intended that these embodiments describe all possible forms of the invention. Rather, the words used in the specification are words of description rather than limitation, and it is understood that various changes may be made without departing from the spirit and scope of the invention. Additionally, the features of various implementing embodiments may be combined to form further embodiments of the invention.

What is claimed is:

1. A toilet training system comprising:
a toy toilet having an external reward receptacle and an internal reward storage chamber; and
a plurality of reward cards each sized to be received in the external reward receptacle and internal reward storage chamber.

2. The toilet training system of claim 1 further comprising a doll sized to be positioned on the toy toilet.

3. The toilet training system of claim 2 wherein the doll has a rear portion formed to cooperate with a lid of the toy toilet to maintain the doll in a seated position on the toy toilet.

4. The toilet training system of claim 3 wherein the rear portion of the doll is filled with a material being denser than a body filling material which fills a body of the doll.

5. The toilet training system of claim 2 further comprising a book having toilet training instructions relating to the toy toilet and the doll.

6. The toilet training system of claim 1 wherein the toy toilet has a slot extending from an exterior surface to the internal reward storage chamber, the slot sized to receive at least one of the plurality of reward cards.

7. The toilet training system of claim 6 wherein the external rewards receptacle is formed on a first lateral side of the toy toilet and the slot is formed on a second lateral side of the toy toilet.

8. The toilet training system of claim 1 wherein the toy toilet has a lid hinged to pivot between an open position and a closed position, wherein in the open position, the internal reward storage chamber is accessible and in the closed position, the internal reward storage chamber is concealed.

9. The toilet training system of claim 1 wherein each of the of reward cards have an interactive activity instruction.

10. A toilet training system comprising:
a toy toilet having a reward system; and
a plurality of reward pieces each sized to be received in the reward system.

11. The toilet training system of claim 10 wherein the reward system comprises an internal storage chamber sized to receive the plurality of reward pieces.

12. The toilet training system of claim 11 wherein the reward system comprises a slot extending from an exterior surface to the internal storage chamber, the slot sized to receive at least one of the plurality of reward pieces.

13. The toilet training system of claim 11 wherein the toy toilet has a lid hinged to pivot between an open position and a closed position, wherein in the closed position, the internal storage chamber is concealed within a bowl portion of the toy toilet.

14. The toilet training system of claim 10 wherein the reward system comprises an external reward pocket sized to receive at least one of the reward pieces.

15. The toilet training system of claim 10, wherein the reward system comprises at least two reward storage containers each sized to receive at least one of the plurality of reward pieces.

16. The toilet training system of claim 10 wherein the plurality of reward pieces comprise a plurality of cards.

17. A toilet training system comprising:
a toy toilet having at least two reward storage containers;
a plurality of reward cards each sized to be received in the reward storage containers; and
a doll sized to be positioned on the toy toilet,
wherein each of the two reward storage containers are accessible to receive at least one of the plurality of reward cards while the doll is positioned on the toy toilet.

18. The toilet training system of claim 17 wherein the at least two reward storage containers comprise an external reward receptacle and an internal reward storage chamber.

19. The toilet training system of claim 18 wherein the internal reward storage chamber is accessible via a slot extending from an exterior surface of the toy toilet to the internal reward storage chamber.

20. The toilet training system of claim 18 wherein the external reward receptacle comprises a pocket positioned along an exterior surface of the toy toilet.
